(19) United States
(12) Patent Application Publication
(10) Pub. No.: US 2002/0009298 A1
(43) Pub. Date: Jan. 24, 2002

(54) Camera or date data reading apparatus

(76) Inventors: Masanobu Akutsu, Kanagawa (JP); Kayoko Kuroda, Kanagawa (JP)

Correspondence Address: ROBIN BLECKER & DALEY, 2ND FLOOR, 330 MADISON AVENUE, NEW YORK, NY, 10017, US

(21) Appl. No.: 09/900,389

(22) Filed: Jul. 6, 2001

(30) Foreign Application Priority Data
Jul. 12, 2000 (JP) 211693/2000

(51) Int. Cl. G03B 17/24

(52) U.S. Cl. 396/319

(57) ABSTRACT

This invention discloses a camera including a magnetic recording unit for recording information on the magnetic recording portion of a film, a timepiece unit for counting a date, and a control unit for controlling and causing the magnetic recording unit to record first image taking date information containing last two digits of a dominical year and second image taking date information containing four digits of the dominical year on the magnetic recording portion of the photographic film on the basis of the output from the timepiece unit, and an apparatus for printing the first image taking date information containing the last two digits of the dominical year, which recorded on the magnetic recording portion of the film, as a four digits dominical year.

### BACKGROUND OF THE INVENTION

1. Field of the Invention

The present invention relates to a camera having a function of recording image taking date information on the magnetic recording portion of a photographic film or an image input/output apparatus and recording medium.

2. Related Background Art

A camera which takes a picture on a photosensitive material such as a silver halide film and has a function of recording the image taking date is very popular. An advanced photo system (to be referred to as APS hereinafter) camera using a film having a magnetic recording portion employs a technique of writing image taking date information on the magnetic recording portion. A camera using a film without any magnetic recording portion employs a technique of printing the image taking date on the film by an LED or the like.

A current camera records an image taking year generally by indicating the last two digits of the dominical year. For a camera which prints an image taking date on a film by an LED or the like, Japanese Patent Application Laid-Open No. 7-1914401 discloses a method of recording a four digits image taking year. An APS camera magnetically records a two digits image taking year on a film although the camera itself has a calendar function (timepiece means) and therefore holds four digits dominical year information. This is because data in a small amount should be recorded.

Year and date information is described in various orders such as year/month/day, day/month/year, and month/day/year in accordance with the country habit or personal taste and can be recorded in any orders by a camera.

However, if the method of indicating the last two digits of a year is still employed from 2001, for example, “01/02/03” can be understood in various ways as Feb. 3, 2001, Feb. 1, 2003, or Jan. 2, 2003.

### SUMMARY OF THE INVENTION

It is the first object of the present invention to provide a camera which can give a photographic print or digital image with image taking date information represented by a four digits dominical year so as to allow a user to easily recognize the image taking date.

It is the second object of the present invention to provide an image input apparatus and recording medium, which can output a photographic print or digital image with image taking date information represented by a four digits dominical year so as to allow a user to easily recognize the image taking date.

According to one aspect of the present invention, there is provided a camera comprising:

magnetic recording means for recording information on a magnetic recording portion;

timepiece means for counting a date; and

control means for controlling and causing the magnetic recording means to record first image taking date information containing last two digits of a dominical year and second image taking date information containing four digits of the dominical year on the magnetic recording portion of the photographic film on the basis of an output from the timepiece means.

The magnetic recording portion has a first recording portion on which the date is recorded and a second recording portion on which an image taking title is recorded, and the control means controls the magnetic recording means to record the first image taking date information on the first recording portion and the second image taking date information on the second recording portion.

Alternatively, the camera comprises control means for controlling and causing the magnetic recording means to record first image taking date information containing last two digits of a dominical year and second image taking date information containing first two digits of the dominical year on the magnetic recording portion of the photographic film on the basis of an output from the timepiece means.

According to another aspect of the present invention, there is provided a reading apparatus for reading information on a photographic film having a magnetic recording portion on which first date information containing last two digits of a dominical year is recorded, comprising:

timepiece means for counting time;

reading means for reading the information recorded on the magnetic recording portion; and

conversion means for converting the first date information into date information containing four digits of the dominical year on the basis of the first date information read by the reading means and timepiece information from the timepiece means.

The apparatus further comprises print output means for printing and outputting the date information containing the four digits of the dominical year converted by the conversion means.

When a number representing the last two digits of the dominical year in the first date information is equal to or smaller than a number representing last two digits of a dominical year by the timepiece means, the conversion means converts the first date information into the date information containing the four digits of the dominical year by using first two digits of the dominical year by the timepiece means as first two digits of the dominical year in the first date information.

When a number representing the last two digits of the dominical year in the first date information is larger than a number representing last two digits of a dominical year by the timepiece means, the conversion means converts the first date information into the date information containing the four digits of the dominical year by using a value obtained by subtracting 1 from first two digits of the dominical year by the timepiece means as first two digits of the dominical year.

When a number representing the last two digits of the dominical year in the first date information is one of “96 to 99”, the conversion means obtains, as a dominical year, a value obtained by adding “1900” and a “number” representing the last two digits of the dominical year in the first date information.

When a number representing the last two digits of the dominical year in the first date information is one of “00 to 95”, the conversion means obtains, as a dominical year, a value obtained by adding “2000” and a “number” representing the last two digits of the dominical year in the first date information.

The present invention also discloses a reading apparatus for reading information on a photographic film having a magnetic recording portion on which first date information containing last two digits of a dominical year is recorded, comprising:

reading means for reading the information recorded on the magnetic recording portion; and

conversion means for converting the first date information into date information containing four digits of the dominical year on the basis of the first date information read by the reading means and timepiece information from timepiece means.

### BRIEF DESCRIPTION OF THE DRAWINGS

FIG. 1 is a block diagram showing the circuit arrangement of an image input/output apparatus according to the first embodiment of the present invention;

FIG. 2 is a flow chart showing the print output operation of the image input/output apparatus shown in FIG. 1;

FIG. 3 is a flow chart showing the image file output operation of the image input/output apparatus shown in FIG. 1;

FIG. 4 is a view showing the configuration of a file of a digital image and attached image information according to the first embodiment of the present invention;

FIG. 5 is a view showing the outer appearance of a camera according to the second embodiment of the present invention;

FIG. 6 is a block diagram showing the circuit arrangement of the camera shown in FIG. 5;

FIG. 7 is a flow chart showing the operation of the main part of the camera shown in FIG. 5;

FIG. 8 is a flow chart showing the operation of the main part of the camera shown in FIG. 5;

FIG. 9 is a view showing the recording area of a film used for image taking by the camera shown in FIG. 5;

FIGS. 10A, 10B and 10C are views showing print examples of a four digits image taking date in the camera shown in FIG. 5 and a print example in a conventional camera;

FIG. 11 is a flow chart showing the operation of the main part of a camera according to the third embodiment of the present invention;

FIG. 12 is a flow chart showing the operation of the main part of an image input/output apparatus according to the third embodiment of the present invention; and

FIG. 13 is a view showing an image input/output system according to the fourth embodiment of the present invention.

### DETAILED DESCRIPTION OF THE PREFERRED EMBODIMENTS

The embodiments of the present invention will be described below in detail with reference to the accompanying drawings.

(First Embodiment)

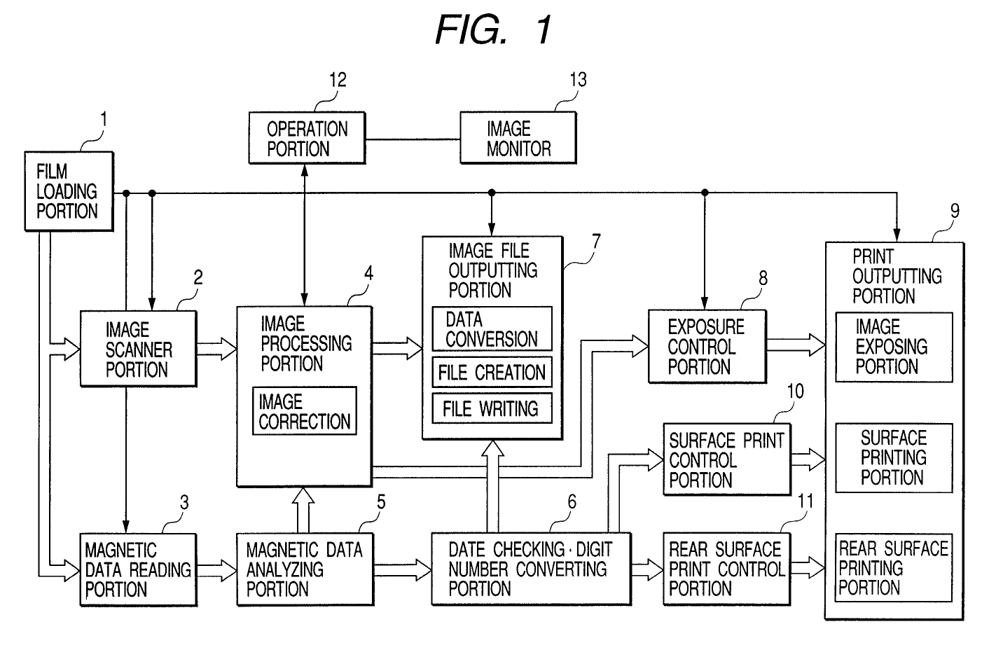

FIG. 1 is a block diagram showing the circuit arrangement of an image input/output apparatus according to the first embodiment of the present invention. This image input/output apparatus has both a film scanner function capable of digitally reading and processing the image of a developed film by a scanner and then outputting the image as an image file and a print output function of reading an image and exposing a film on the basis of the image processing result.

Referring to FIG. 1, a developed film is loaded in a film loading portion 1. An image scanner portion 2 constructed by a light source and photoelectric conversion element such as a CCD digitally reads the image of the loaded film. A magnetic data reading portion 3 formed from a magnetic head and signal amplifier reads the magnetic data at the time of image taking, which is coded and recorded on the rear film surface of a frame corresponding to the image read by the image scanner portion 2. An image processing portion 4 calculates luminance information and color information of the image from the entire image data read by the image scanner portion 2 and converts or corrects the image characteristic in accordance with the output state. A magnetic data analyzing portion 5 analyzes the data coded at the time of image taking, which is read by the magnetic data reading portion 3. A date checking/digit number converting portion 6 collates the image taking date information analyzed by the magnetic data analyzing portion 5 with calendar information incorporated in that apparatus and converts the two digits image taking year on the film into a four digits image taking year.

An image file outputting portion 7 creates a file by converting or compressing the image data from the image processing portion 4 in accordance with the output file format and transfers or writes the file. An exposure control portion 8 controls the exposure operation of a print outputting portion (to be described later) on the basis of the processing by the image processing portion 4. A print outputting portion 9 includes an image exposing portion, surface printing portion, and rear surface printing portion. The image exposing portion has a print exposure control portion and development processing portion as a portion for printing an image on, e.g., print paper, or may be formed from an inkjet printer, sublimation printer, or laser beam printer.

A surface print control portion 10 and rear surface print control portion 11 control print contents and positions on both surfaces in accordance with the information from the magnetic data analyzing portion 5. To print an image taking year, four digits information converted in accordance with the information from the date checking/digit number converting portion 6 is used. An operation portion 12 can execute operation such as processing state confirmation and image correction instruction through an image monitor 13.

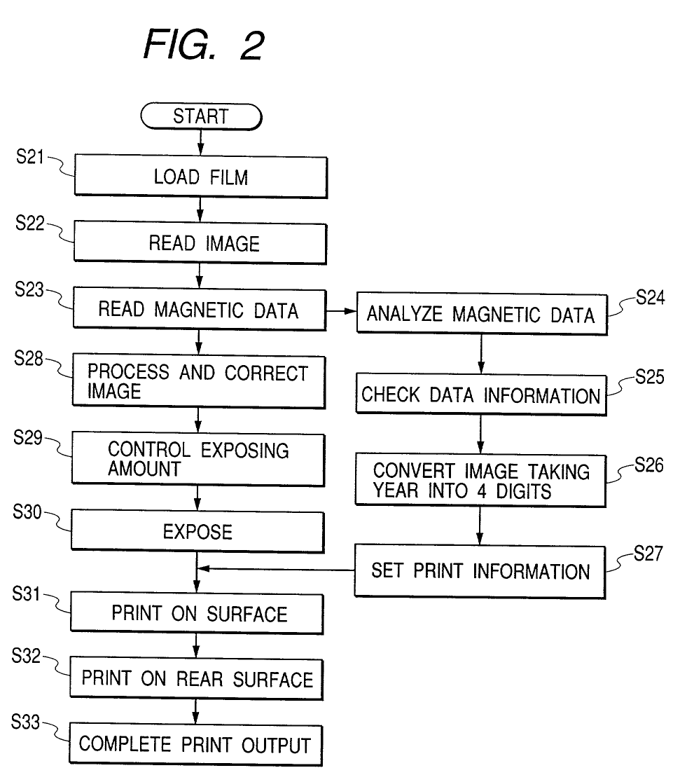

Operation of printing and outputting an image recorded on a film will be described next with reference to the flow chart shown in FIG. 2.

When a film is loaded in the film loading portion 1 of the image input/output apparatus having the above arrangement (step S21), the image scanner portion 2 formed from a light source and photoelectric conversion element such as a CCD digitally reads the image on the film (step S22). Next, the magnetic data reading portion 3 formed from a magnetic head and signal amplifier reads magnetic data at the time of image taking, which is coded and recorded on the rear film surface of the frame corresponding to the image read by the image scanner portion 2 (step S23). The order of operations in steps S22 and S23 may be reversed.

The magnetic data read in step S23 is analyzed by the magnetic data analyzing portion 5 (step S24). Of the analyzed image taking data, image taking date information is collated with calendar information incorporated in the apparatus by the date checking/digit number converting portion 6 (step S25). The processing branches to a case (A) wherein the last two digits of the image taking year are equal to or smaller than the last two digits of the current year in the calendar incorporated in the apparatus or a case (B) wherein the last two digits of the image taking year are larger than the last two digits of the current year. In the case (A), the two digits image taking year recorded on the magnetic recording portion of the film is converted into four digits by using the first two digits of the current year to the first two digits of the image taking year. In the case (B), the two digits image taking year is converted into four digits by using a number obtained by subtracting 1 from the first two digits of the current year to the first two digits of the image taking year (step S26).

As APS cameras have been commercially available since 1996, a two digits image taking year may be converted into four digits by, e.g., adding “1900” when the last two digits of the image taking year are “96 to 99” and “2000” when the last two digits are “00 to 95”.

Pieces of print information on both surfaces, which are obtained by analysis by the magnetic data analyzing portion 5 (step S24), are set in the surface print control portion 10 and rear surface print control portion 11 (step S27). When the print information contains the image taking year, the four digits dominical year converted in step S26 is used.

The image processing portion 4 calculates the luminance information and color information of the image read in step S22 and processes the image (step S28). The exposure control portion 8 appropriately controls the exposing amount in accordance with the image processing (step S29), and the image exposing portion in the print outputting portion 9 exposes the image (step S30).

The surface printing portion in the print outputting portion 9 prints the surface print contents (the image taking year has four digits) set in step S27 on the print image (surface) exposed in step S30 (step S31), and subsequently, the rear surface printing portion in the print outputting portion 9 prints the rear surface print contents (the image taking year has four digits) set in step S27 on the rear print surface (step S32), thereby completing print output of one frame (step S33).

If the print outputting portion 9 executes digital image output, the image to be exposed in step S30 and the surface print contents in step S31 may be synthesized in advance, and the image and surface characters may be simultaneously exposed and printed.

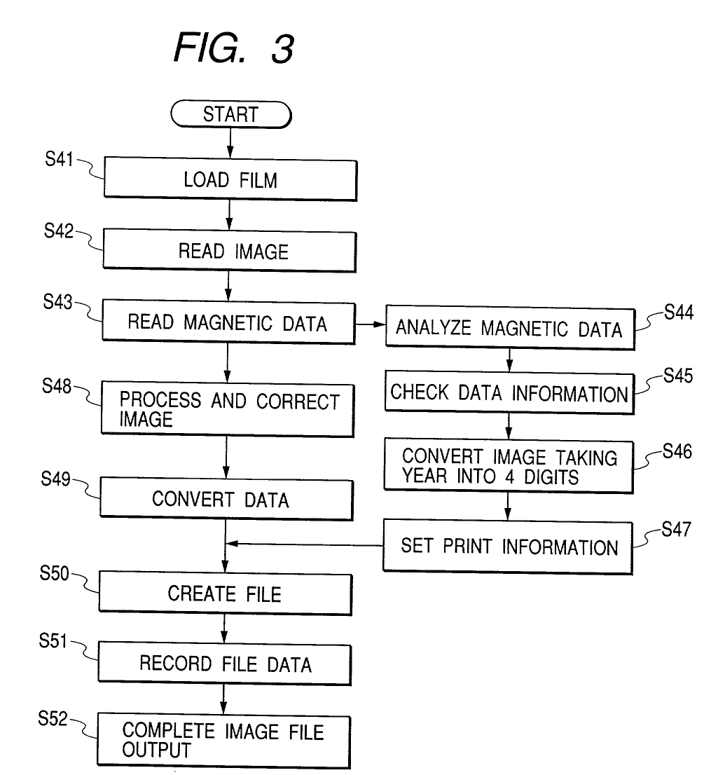

Operation of converting an image recorded on a film into digital data and outputting the image as an image file will be described next with reference to the flow chart shown in FIG. 3.

Referring to FIG. 3, processing from film loading in step S41 to print information setting in step S47 is the same as that of the print output operation shown in FIG. 2 (S21 to S27), and a detailed description thereof will be omitted.

The image processing portion 4 calculates the luminance information and color information of the image read in step S42 and corrects the image (step S48). The image file outputting portion 7 also executes data conversion such as image conversion and image compression in accordance with the output file format and output file size (step S49). A file is created by attaching, to the converted image data, a four digits image taking year set in step S47 as data attached to the image (step S50), and the file data is recorded by transferring and writing (storing) the file (step S51), thereby completing image file output (step S52).

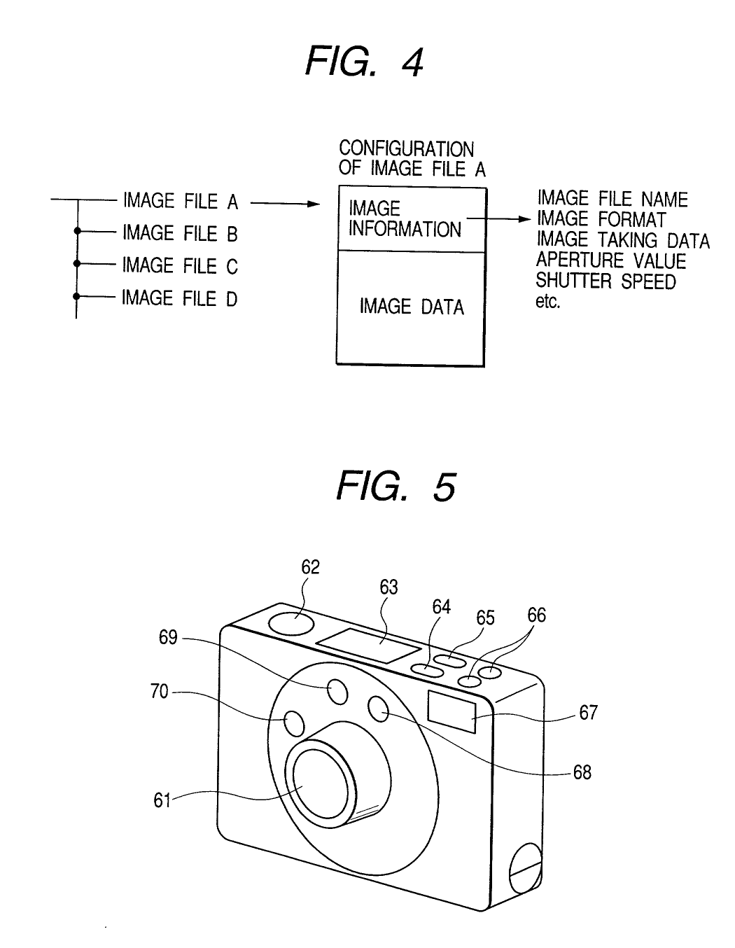

FIG. 4 is a view showing the configuration of a file of a digital image and attached image information.

A known image file such as a CIFF file or TIFF file has an image data region and image information region, as shown in FIG. 4. The image information contains image taking date information represented by four digits dominical image taking year as well as image taking information such as an image file name, image format type, shutter speed, and aperture value.

According to the first embodiment, an image input apparatus capable of outputting a print with four digits year information or an image file containing four digits image taking year information even from a film for an APS camera on which the last two digits of image taking date information are recorded can be provided.

(Second Embodiment)

In the above first embodiment, image taking year conversion into four digits by an image input/output apparatus has been described. In the second embodiment of the present invention to be described below, an image taking year is converted into four digits by a standalone APS camera.

FIG. 5 is a view showing the outer appearance of an APS camera according to the second embodiment of the present invention.

Referring to FIG. 5, the camera has an image taking lens 61 and shutter button 62. A display device 63 formed from, e.g., a liquid crystal display panel displays a film counter, warning message, calendar information such as year, month, day, and time, and title contents to be printed. A date button 64 is used to switch display of timepiece information of a calendar IC incorporated in the camera. A title button 65 is used to switch display of titles incorporated in the camera in advance. A selection determination button 66 is used to adjust time of timepiece information or select title contents. The camera also includes a strobe light-emitting portion 67, an objective lens 68 of a finder optical system, a projecting portion 69 of an AF light source for projecting infrared light or the like on an object for the purpose of focusing, and an AF light-receiving portion 70 for receiving the light output from the AF light source and reflected by the object.

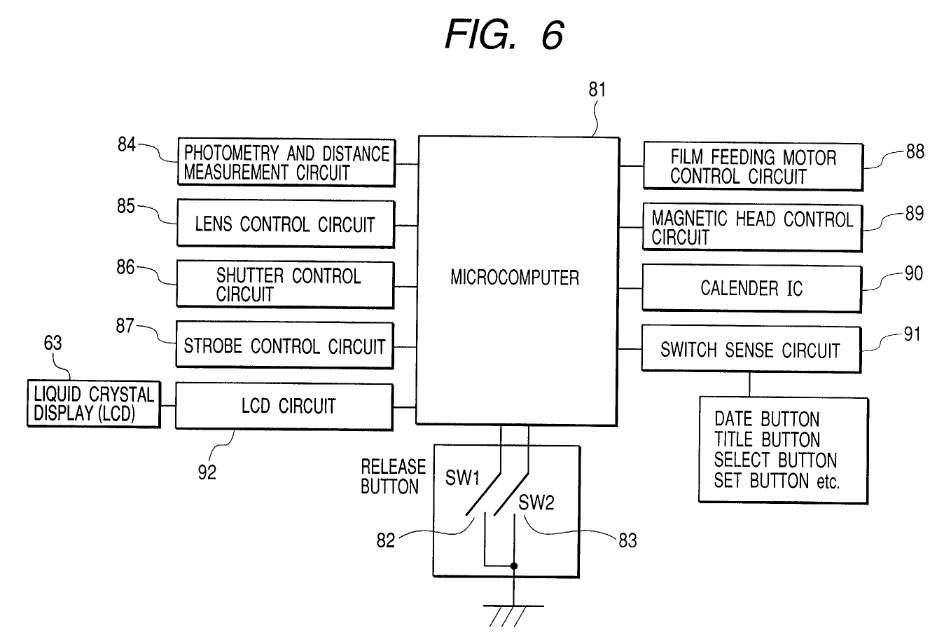

FIG. 6 is a block diagram showing the circuit arrangement of the main part of the camera having the above arrangement.

Referring to FIG. 6, a microcomputer 81 controls the operation of the entire camera. Switches 82 (SW1) and 83 (SW2) are interlocked with the release button 62 shown in FIG. 5. The switch SW1 is turned on at the half stroke of the release button 62, and the switch SW2 is turned on at the full stroke of the release button 62. A photometry and distance measurement circuit 84 measures the luminance of the object and the distance from the object and calculates the exposure conditions and a lens drive amount necessary for focusing. A lens control circuit 85 controls the in-focus operation of the lens on the basis of the lens drive amount calculation result. A shutter control circuit 86 controls the ON/OFF operation of the shutter on the basis of the exposure condition calculation result. A strobe control circuit 87 controls the light emission ON/OFF function by turning on/off the strobe. A film feeding motor control circuit 88 feeds (winds or rewinds) the film in accordance with a signal from the microcomputer 81. A magnetic head control circuit 89 controls a magnetic head for recording data on the magnetic recording portion on the film or reading recorded information.

A calendar IC 90 is constructed by a quartz oscillator and timepiece integrated circuit and automatically counts calendar information such as year, month, day, hour, and minute independently of the operation of the microcomputer 81. A year is counted as a four digits year. The timepiece information is connected such that the microcomputer 81 can read the information anytime.

A switch sense circuit 91 monitors the states of the switch for turning on/off the main power supply of the camera main body, the date button 64 for changing the order of display of the year, month, day, and time of calendar information on a print, and the title button 65 for switching title display. An LCD circuit 92 controls the liquid crystal display device 63 for displaying a state selected by the switch sense circuit 91.

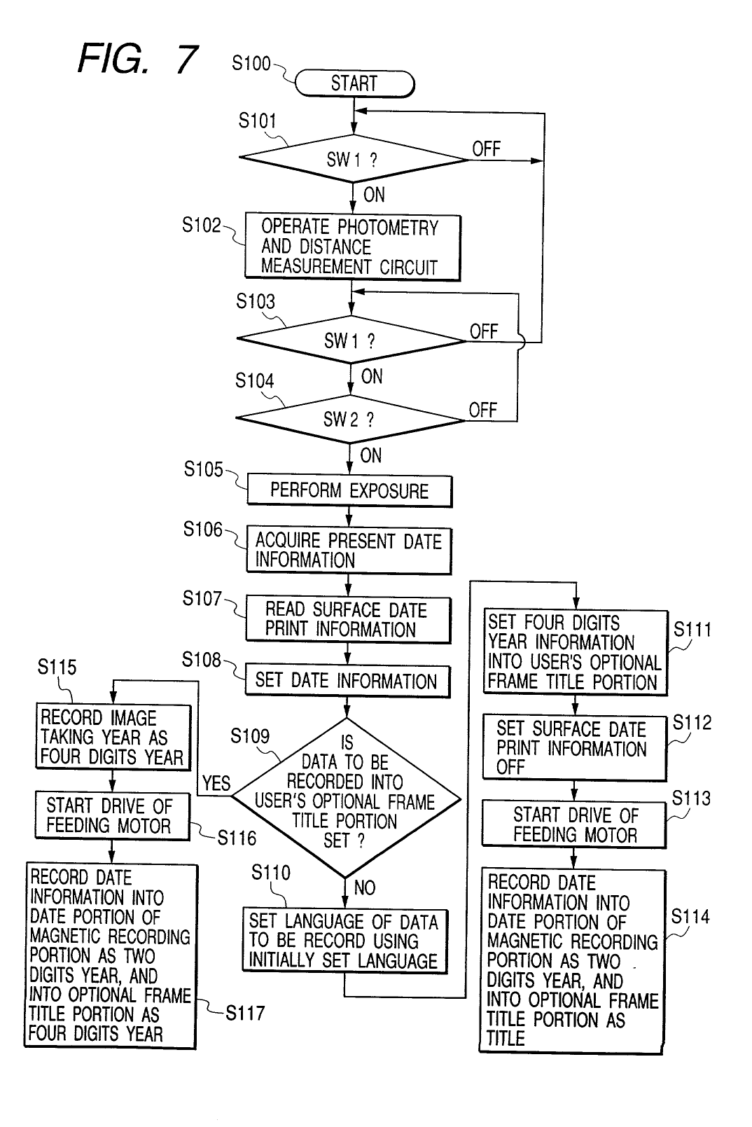

The operation of the main part of the camera having the above arrangement will be described next with reference to the flow chart shown in FIG. 7.

When the camera is powered on by, e.g., pressing the main switch of the camera, the microcomputer 81 starts operation from step S100. Upon detecting that the switch SW1 is turned on at the half stroke of the release button 62 (step S101), the photometry and distance measurement circuit 84 is driven to acquire information related to the object luminance and distance from the object measured herein (step S102). The state of the switch SW1 is detected again (step S103). If the switch SW1 is turned off, the flow returns to step S1OO. If the switch SW1 is kept ON, the state of the switch SW2 is detected (step S104). Upon detecting that the switch SW2 is turned on, the flow advances to step S105. Otherwise, the flow returns to step S103.

In step S105, the lens control circuit 85, shutter control circuit 86, strobe control circuit 87, and the like are driven in accordance with the conditions calculated in step S102 to perform exposure on a film. Next, the timepiece information of the calendar IC 90 is read to acquire present date information (step S106). Of the acquired date information, year information is represented by a four digits dominical year held in the calendar IC 90. The switch sense circuit 91 reads surface date print information (a surface date print selected state by the user, such as year/month/day, day/month/year, month/day/year, or date display OFF) (step S107).

From the present date information acquired in step S106, date information to be recorded on the date portion of the magnetic recording portion of the APS film is set in a predetermined recording region in accordance with the display method instructed in step S107 (step S108). The image taking year information is represented by the last two digits of the dominical year on the basis of the recording standard of the date portion of the APS film. The magnetic recording portion of the APS film has a space called a “user's optional frame title portion” where the user can record an arbitrary title for each frame. It is determined whether data to be recorded into the user's optional frame title portion is set (step S109). If NO in step S109, the flow advances to step S110.

In step S110, a language of data to be recorded into the user's optional frame title portion is set to the language initially set in the camera (Japanese for a camera for use in Japan, English for a camera for use in the U.S.A., and French for a camera for use in France). The date information is expressed by Arabic numerals independently of the selected language. Next, in accordance with the date display method read in step S107, the date information containing the four digits dominical year information obtained from the calendar IC 90 in step S106 is set in the user's optional frame title portion (step S111).

For example, when the date display method selected in step S107 is “month/day/year”, and “03/07/02” is set in step S108, “03/07/2002” is set in step S111.

The surface date print information input through the switch sense circuit 91 is changed to “OFF (no surface date print)” (step S112). With this processing, the normal date display in the APS camera, i.e., the surface print display of the last two digits of the dominical year is turned off and hence prevented from being superposed on the four digits dominical year set in the user's optional frame title portion.

When the input items of magnetic information for the user's optional frame title portion and date portion and all other pieces of image taking information are set, the microcomputer 81 starts driving the feeding motor through the film feeding motor control circuit 88 (step S113), drives the magnetic head control circuit 89 upon winding one frame so as to record the date information on the date portion and user's optional frame title portion of the magnetic recording portion of the film and other pieces of image taking information on a predetermined portion (step S114).

The pieces of magnetic information related to the date and title, which are recorded in step S114, are

date recording portion: two digits year

user's optional frame title portion: four digits year

surface date print setting: OFF

The subsequent operation is almost the same as in a normal camera, and a description thereof will be omitted.

If YES in step S109, the flow advance to step S115 to cause the microcomputer 81 store the four digits image taking year. When storage is completed, the microcomputer 81 starts driving the feeding motor through the film feeding motor control circuit 88 (step S116) and writes the date information, title, and other pieces of image taking information on the magnetic recording portion of the film (step S117).

The pieces of magnetic information related to the date and title, which are recorded in step S117, are

date recording portion: two digits year

user's optional frame title portion: frame title input and set by the user

surface date print setting: user setting

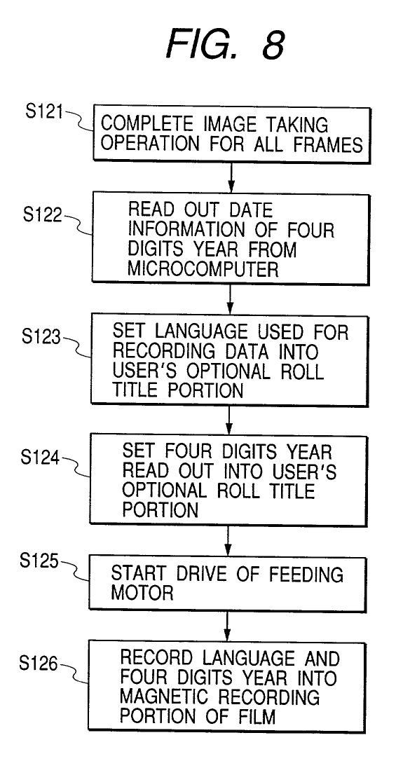

Operation after the end of image taking for all frames when image taking frames of one film include a frame to which a user's optional frame title portion (e.g., “Banzai” to be described later) is input will be described next with reference to the flow chart shown in FIG. 8.

When image taking operation for all frames is completed (step S121), the four digits image taking year stored in step S115 is read out (step S122). A language used for a user's optional roll title portion where data to be recorded on the magnetic recording portion of the leader portion of the film is set (step S123). The language initially set in the camera is set, as in step S110, though the date information is expressed by Arabic numerals independently of the selected language.

The four digits image taking year read out in step S122 is set into the user's optional roll title portion. If a plurality of image taking years are read out, and they are the same, e.g., “2001” is set. If a plurality of image taking years are read out, and they are different, e.g., “2001-2002” is set.

When the language and four digits image taking year for the user's optional roll title portion are set, the microcomputer 81 starts driving the feeding motor through the film feeding motor control circuit 88 (step S125) and starts rewinding the film. The language and four digits image taking year information set in the user's optional roll title portion in steps S123 and S124 are recorded on the magnetic recording portion of the leader portion at the end of the rewound film (step S126).

As described above, by inputting the four digits image taking year to the user's optional roll title portion, the four digits image taking year is printed on the print, and the user can accurately recognize the year/month/day.

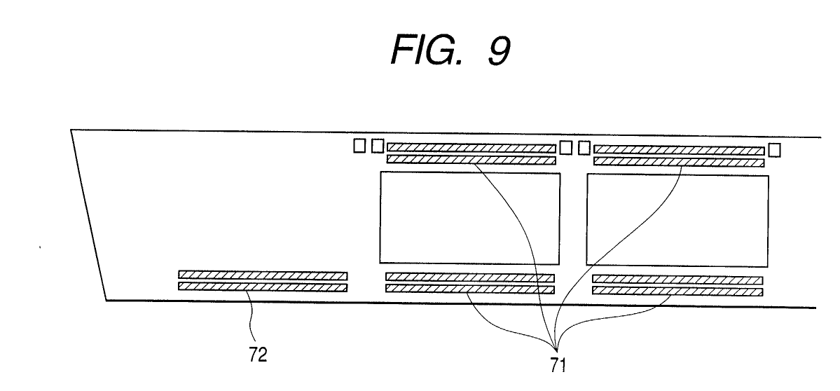

FIG. 9 is a view showing the magnetic information recording area of a developed film for the APS camera. Pieces of information at the time of image taking are coded and recorded as magnetic data on the rear film surface side, as indicated by reference numerals 71 and 72. In steps S114, S117, and S126, magnetic data is written. In steps S114 and S117, the pieces of information are recorded on the magnetic recording portions 71 corresponding to the frames. In step S126, the information (user's optional roll title information) is recorded on the magnetic recording portion 72 of the leader portion of the film.

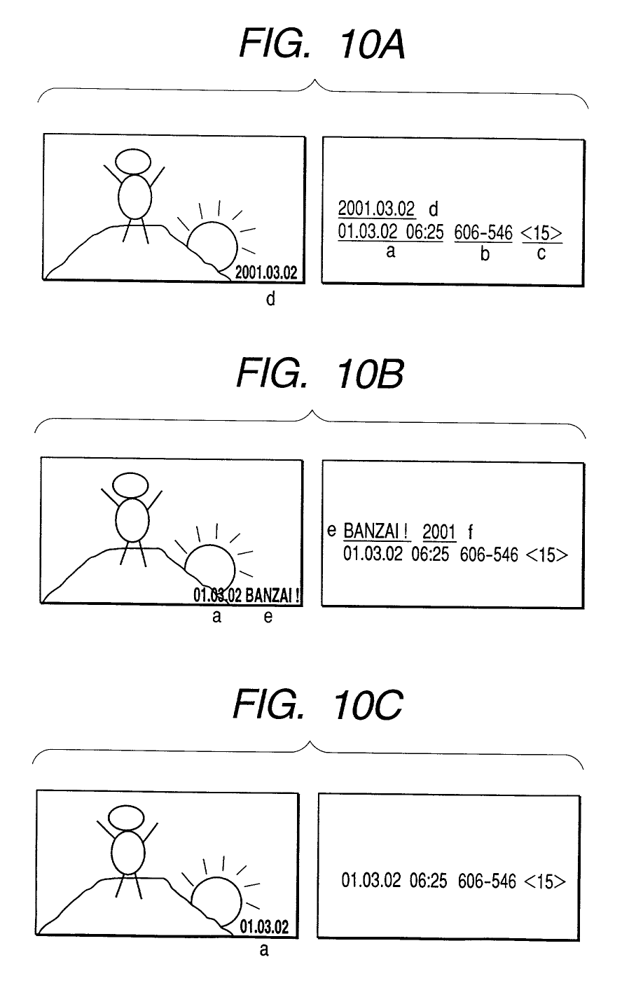

FIGS. 10A to 10C are views showing date print examples for a photographic film obtained in the above way. Referring to FIGS. 10A to 10C, print examples on the print surface are shown on the left side, and print examples on the rear print surface are shown on the right side.

Referring to FIGS. 10A to 10C, a date a is printed using a two digits dominical year recorded on the magnetic recording portion (date portion) of an APS film. A film ID b and frame number c of the APS film are printed on the rear surface. A four digits date d is input to the user's optional frame title portion, a title e is input to the user's optional frame title portion, and a four digits dominical image taking year f is input to the user's optional roll title portion.

FIG. 10A shows a print example in which a four digits dominical year is recorded in the optional title portion of the film in step S114 in FIG. 7. Since the four digits year is printed on both surfaces, a correct date can be recognized.

FIG. 10B shows a print example in which pieces of information described in step S117 of FIG. 7 and in step S126 of FIG. 8 are recorded. Since a title “Banzai” is input and set into the user's optional frame title portion, only a two digits image taking year as normal date information for an APS camera is printed on the surface. However, since the image taking year is input to the user's optional roll title portion, “2001” is printed as the image taking year f, and a correct date can be recognized.

FIG. 10C shows an example in which only a two digits dominical year is recorded in a conventional camera that has no arrangement of the present invention. Since a two digits year is printed on both surfaces, the user cannot determine the correct date.

As described above, when the camera having the function of converting an image taking year into four digits is used, a print having a four digits dominical image taking year can be obtained even when an image input/output apparatus does not cope with image taking year conversion into four digits, unlike the first embodiment.

(Third Embodiment)

In the first embodiment, image taking year conversion into four digits by a standalone image input/output apparatus has been described. In the second embodiment, image taking year conversion into four digits by a standalone camera has been described. In the third embodiment of the present invention, an example of conversion into four digits by both a camera and an image input/output apparatus will be described below.

The arrangements of the image input/output apparatus and camera are the same as those in the first and second embodiments, and a detailed description thereof will be omitted.

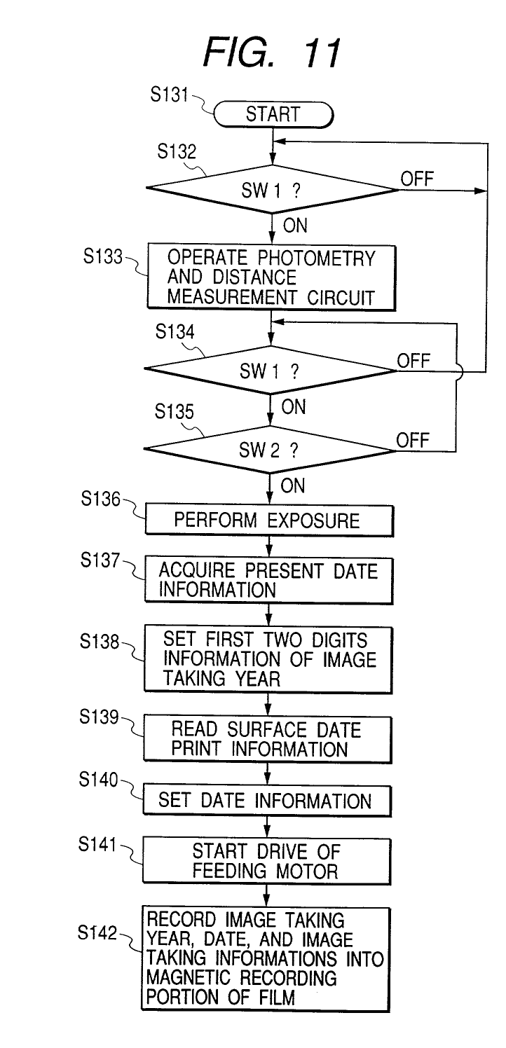

The operation of the camera will be described below with reference to the flow chart shown in FIG. 11.

When the camera is powered on by, e.g., pressing the main switch of the camera, operation starts from step S131. Upon detecting that a switch SW1 is turned on at the half stroke of a release button 62 (step S132), a photometry and distance measurement circuit 84 is driven to acquire information related to the object luminance and distance from the object measured herein (step S133). The state of the switch SW1 is detected again (step S134). If the switch SW1 is turned off, the flow returns to step S132. If the switch SW1 is kept ON, the state of a switch SW2 is detected (step S135). Upon detecting that the switch SW2 is turned on, the flow advances to step S136. Otherwise, the flow returns to step S134.

In step S136, a lens control circuit 85, shutter control circuit 86, strobe control circuit 87, and the like are driven in accordance with the conditions calculated in step S133 to perform exposure on a film. Next, the timepiece information of a calendar IC 90 is read to acquire present date information (step S137). The numerical value representing the first two digits of the current year (“19” for 1999 and “20” for 2000) is set as information to be added to the two digits image taking year of the date (step S138). A switch sense circuit 91 reads surface date print information (a surface date print selected state by the user, such as year/month/day, day/month/year, month/day/year, or date display OFF) (step S139). The present date information acquired in step S137 is set in accordance with the display method instructed in step S139 (step S140). The image taking year information set in step S140 is represented as a two digits year on the basis of the APS standard.

Although not illustrated in the flow chart, when other pieces of image taking information to be written as magnetic information (shutter speed, aperture value, luminance, and strobe ON/OFF information) are set in a microcomputer 81, in addition to the date information and information of the first two digits of the image taking year, drive of the feeding motor is started (step S141). The microcomputer 81 drives a magnetic head control circuit 89 upon winding one frame so as to write the image taking year, date information, and other image taking information set in steps S139 and S140 on the magnetic recording portion of the film (step S142).

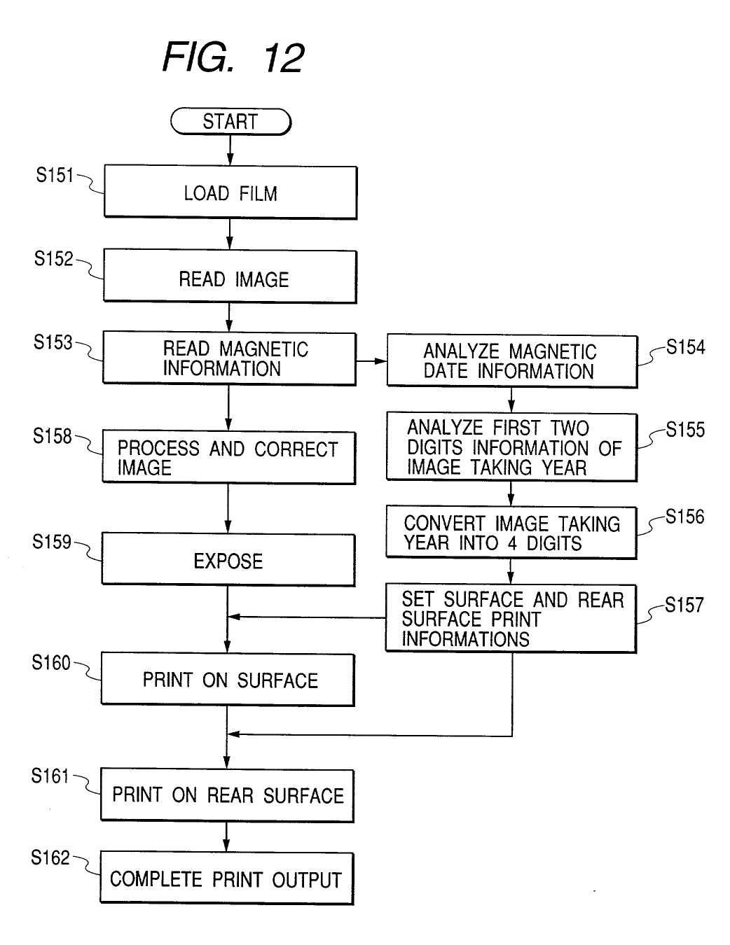

The operation of the image input/output apparatus when a film on which the information of the first two digits of the image taking year is recorded is printed by the camera will be described next with reference to the flow chart shown in FIG. 12.

When a film is loaded (step S151), an image scanner portion 2 formed from a light source and photoelectric conversion element such as a CCD digitally reads the image on the loaded film (step S152). Next, a magnetic data reading portion 3 formed from a magnetic head and signal amplifier reads magnetic data at the time of image taking, which is coded and recorded on the rear film surface of the frame corresponding to the image read by the image scanner portion 2 (step S153). The order of operations in steps S152 and S153 may be reversed.

The magnetic data read in step S153 is analyzed by a magnetic data analyzing portion 5, and the date print information recorded on the date recording portion is discriminated (step S154). Of the date information, the image taking year is represented only by the last two digits as defined in the APS standard. In addition, the information of the first two digits that is magnetically recorded is also analyzed (step S155). Using the information obtained in steps S154 and S155, the image taking year is converted into four digits by a date checking/digit number converting portion 6. The date checking/digit number converting portion 6 can convert the year into four digits by collating the magnetic information with the calendar function of the apparatus itself, as described in the first embodiment. Alternatively, the date checking/digit number converting portion 6 may convert the image taking year into four digits by collating a plurality of pieces of magnetic information (image taking year information represented by the last two digits (step S154) and the information of the first two digits of the image taking year (step S155)).

Pieces of print information on both surfaces of the print, which are analyzed in step S154, are set in a surface print control portion 10 and rear surface print control portion 11 (step S157). When the print information contains the image taking year, the four digits year converted in step S156 is set.

An image processing portion 4 calculates the luminance information and color information of the image read in step S152 and processes the image (step S158). An exposure control portion 8 appropriately controls the exposing amount in accordance with the image processing (step S159), and an image exposing portion in a print outputting portion 9 exposes the image (step S150). A surface printing portion in the print outputting portion 9 prints the surface print contents (the image taking year has four digits) set in step S157 on the exposed print image (step S160), and subsequently, a rear surface printing portion in the print outputting portion 9 prints the rear surface print contents (the image taking year has four digits) set in step S157 on the rear print surface (step S161), thereby completing print output of one frame (step S162).

If the print outputting portion 9 executes digital image output, the image to be exposed in step S159 and the surface print contents in step S160 may be synthesized in advance, and the image and surface characters may be simultaneously exposed and printed.

As described above, when the camera independently records the image taking year information of the first two digits on the magnetic recording portion of the film, and the image input/output apparatus reads the recorded year information of the first two digits, a print having a four digits image taking year can more easily be obtained.

In the third embodiment, the numerical information of the first two digits of a dominical year is stored in the film. For a camera commercially available from 2000, more simply, only a four digits conversion flag may be recorded, and the image input/output apparatus may read the four digits conversion flag and output information with “20” added to the year of the recorded date information.

The third embodiment can also be applied to a scanner or the like, like the first embodiment, so a file of a digital image having four digits image taking year information can be output.

(Fourth Embodiment)

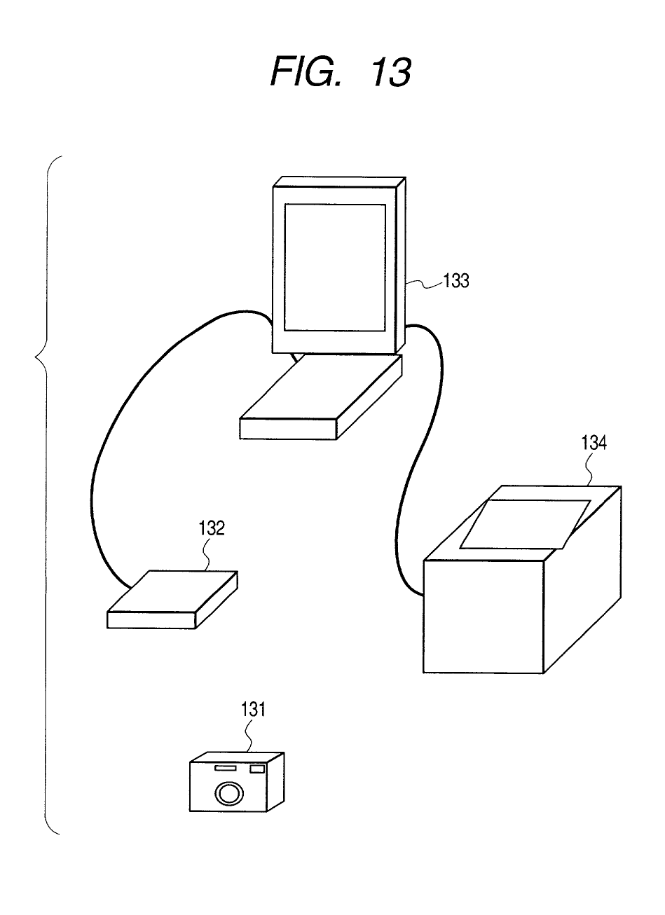

FIG. 13 is a view showing the fourth embodiment of the present invention. The operation is the same as one of the first to third embodiments.

Referring to FIG. 13, an APS camera 131 takes an image using a silver halide film. The APS camera 131 incorporates a microcomputer. For the second or third embodiment, an algorithm for image taking date conversion (a two digits dominical year is converted into a four digits dominical year) is stored in a ROM or RAM as software. A scanner 132 receives an image, and in this case, is formed from a film scammer capable of reading a transparent original. A personal computer 133 with a monitor has an image taking date conversion function for the first or third embodiment. The system also has a printer 134. The above components construct an image output system.

When the image taking date conversion algorithm is prepared as software and stored in a recording medium such as a CD-ROM or floppy disk, and the recording medium is inserted into the personal computer 133 and used, the operation of the above-described first or third embodiment can be executed. Since an image input/output system can easily be constructed using the above software and commercially available camera, scanner, personal computer, and printer, many people can practice the system at a low cost.

In the fourth embodiment, the devices are connected in a physical form such as a cable. However, they may be connected by a communication means using a radio wave or infrared light.

The effects of the above embodiments will be listed below.

1) When the image input/output apparatus is designed to have a function of converting the information of an image taking year represented by the last two digits of a dominical year, which is recorded on the user's optional roll title portion of a photographic film, into four digits and adding the information to a print or digital image, a file of a print or digital image having the information of a four digits dominical year can be output, and the user can easily discriminate the date.

2) Even for an image input/output apparatus which does not cope with image taking year conversion into four digits, when the camera is designed to have a means for recording image taking date information represented by both the last two digits and four digits of a dominical year on the magnetic recording portion of a film, the user can obtain a print or digital image having the information of a four digits dominical year and recognize the correct date.

3) When a recording medium having an image taking date conversion algorithm corresponding to the characteristic portion of the present invention is prepared and caused to function through a microcomputer, an inexpensive image input/output system using commercially available devices can be constructed without using any special device or mechanism.

As has been described above, the present invention can provide a camera capable of giving a photographic print or digital image having image taking date information containing a four digits dominical year such that the user can easily recognize the image taking date.

The present invention can also provide an image input apparatus or recording medium capable of giving a photographic print or digital image having image taking date information containing a four digits dominical year such that the user can easily recognize the image taking date.

What is claimed is:

1. A camera which can use a photographic film having a magnetic recording portion, comprising:
magnetic recording means for recording information on the magnetic recording portion;
timepiece means for counting a date; and
control means for controlling and causing said magnetic recording means to record first image taking date information containing last two digits of a dominical year and second image taking date information containing four digits of the dominical year on the magnetic recording portion of the photographic film on the basis of an output from said timepiece means.

2. A camera according to claim 1, wherein
said magnetic recording portion has a first recording portion on which the date is recorded and a second recording portion on which an image taking title is recorded, and
said control means controls said magnetic recording means to record the first image taking date information on the first recording portion and the second image taking date information on the second recording portion.

3. A camera which can use a photographic film having a magnetic recording portion, comprising:
magnetic recording means for recording information on the magnetic recording portion;
timepiece means for counting a date; and
control means for controlling and causing said magnetic recording means to record first image taking date information containing last two digits of a dominical year and second image taking date information containing first two digits of the dominical year on the magnetic recording portion of the photographic film on the basis of an output from said timepiece means.

4. A camera according to claim 3, wherein
said magnetic recording portion has a first recording portion on which the date is recorded and a second recording portion on which an image taking title is recorded, and
said control means controls said magnetic recording means to record the first image taking date information on the first recording portion and the second image taking date information on the second recording portion.

5. A reading apparatus for reading information on a photographic film having a magnetic recording portion on which first date information containing last two digits of a dominical year is recorded, comprising:
timepiece means for counting time;
reading means for reading the information recorded on the magnetic recording portion; and
conversion means for converting the first date information into date information containing four digits of the dominical year on the basis of the first date information read by said reading means and timepiece information from said timepiece means.

6. An apparatus according to claim 5, further comprising print output means for printing and outputting the date information containing the four digits of the dominical year converted by said conversion means.

7. An apparatus according to claim 5, wherein when a number representing the last two digits of the dominical year in the first date information is not more than a number representing last two digits of a dominical year by said timepiece means, said conversion means converts the first date information into the date information containing the four digits of the dominical year by using first two digits of the dominical year by said timepiece means as first two digits of the dominical year in the first date information.

8. An apparatus according to claim 5, wherein when a number representing the last two digits of the dominical year in the first date information is larger than a number representing last two digits of a dominical year by said timepiece means, said conversion means converts the first date information into the date information containing the four digits of the dominical year by using a value obtained by subtracting 1 from first two digits of the dominical year by said timepiece means as first two digits of the dominical year.

9. An apparatus according to claim 5, wherein when a number representing the last two digits of the dominical year in the first date information is one of “96 to 99”, said conversion means obtains, as a dominical year, a value obtained by adding “1900” and a “number” representing the last two digits of the dominical year in the first date information.

10. An apparatus according to claim 5, wherein when a number representing the last two digits of the dominical year in the first date information is one of “00 to 95”, said conversion means obtains, as a dominical year, a value obtained by adding “2000” and a “number” representing the last two digits of the dominical year in the first date information.

11. A reading apparatus for reading information on a photographic film having a magnetic recording portion on which first date information containing last two digits of a dominical year is recorded, comprising:
reading means for reading the information recorded on the magnetic recording portion; and
conversion means for converting the first date information into date information containing four digits of the dominical year on the basis of the first date information read by said reading means and timepiece information from timepiece means.

12. An apparatus according to claim 11, further comprising print output means for printing and outputting the date information containing the four digits of the dominical year converted by said conversion means.

13. An apparatus according to claim 11, wherein when a number representing the last two digits of the dominical year in the first date information is one of “96 to 99”, said conversion means obtains, as a dominical year, a value obtained by adding “1900” and a “number” representing the last two digits of the dominical year in the first date information.

14. An apparatus according to claim 11, wherein when a number representing the last two digits of the dominical year in the first date information is one of “00 to 95”, said conversion means obtains, as a dominical year, a value obtained by adding “2000” and a “number” representing the last two digits of the dominical year in the first date information.
